(19) United States
(12) Patent Application Publication
(10) Pub. No.: US 2022/0153411 A1
(43) Pub. Date: May 19, 2022

(54) MOVING BODY, CONTROL METHOD THEREOF, AND PROGRAM

(71) Applicant: Sony Group Corporation, Tokyo (JP)

(72) Inventors: Masahiko TOYOSHI, Tokyo (JP); Kohei URUSHIDO, Tokyo (JP); Shun LEE, Tokyo (JP); Ryuta SATOH, Tokyo (JP); Shinichiro ABE, Tokyo (JP); Takuto MOTOYAMA, Tokyo (JP); Masaki HANDA, Tokyo (JP)

(73) Assignee: Sony Group Corporation, Tokyo (JP)

(21) Appl. No.: 17/438,942

(22) PCT Filed: Mar. 12, 2020
(86) PCT No.: PCT/JP2020/010740

§ 371 Date: Sep. 14, 2021

(30) Foreign Application Priority Data
Mar. 25, 2019 (JP) 2019-055967

(51) Int. Cl. B64C 39/02; B64D 47/08; G05D 1/10; G05D 1/02

(52) U.S. Cl. CPC B64C 39/024; B64D 47/08; B64C 2201/141; G05D 1/0202; G05D 1/101

(57) ABSTRACT

The present technology relates to a moving body, a control method thereof, and a program capable of accurately detecting and avoiding a linear object that can be an obstacle in movement.

The moving body detects a line segment in a captured image captured by at least one camera of a stereo camera, and moves a machine body to which the stereo camera is fixed in a direction orthogonal to the line segment. The present technology can be applied to, for example, a moving body and the like that perform autonomous flight, such as a drone.

### TECHNICAL FIELD

The present technology relates to a moving body, a control method thereof, and a program, and particularly to a moving body, a control method thereof, and a program capable of accurately detecting and avoiding a linear object that can be an obstacle in movement.

### BACKGROUND ART

A moving body that autonomously flies such as a drone, for example, recognizes a position of an object around a machine body from an image captured by a stereo camera, and autonomously moves while avoiding an obstacle.

However, in the object recognition by the stereo camera, it is difficult in principle to recognize an object in which a change in texture is small in a direction of a straight line parallel to a baseline. For example, it is difficult to detect a thin object such as an electric wire or an antenna extending in a horizontal direction of the image. Note that the baseline is a line segment connecting optical centers of two cameras constituting the stereo camera.

Patent Document 1 discloses a technique of flying while maintaining a certain distance from an electric wire on the basis of magnitude of current flowing through the electric wire and imaging the electric wire, as an unmanned flying body that flies to detect an electric wire.

### CITATION LIST

### Patent Document

Patent Document 1: Japanese Patent Application Laid-Open No. 2018-114807

### SUMMARY OF THE INVENTION

### Problems to be Solved by the Invention

However, the technique of Patent Document 1 can cope with only an electric wire during power transmission, and furthermore, can fly only along the electric wire.

The present technology has been made in view of such a situation, and can accurately detect and avoid a linear object that can be an obstacle in movement.

### Solutions to Problems

A moving body according to one aspect of the present technology includes: a line segment detection unit that detects a line segment in a captured image captured by at least one camera of a stereo camera; and a control unit that moves a machine body to which the stereo camera is fixed in a direction orthogonal to the line segment.

In a method of controlling a moving body according to one aspect of the present technology, the moving body detects a line segment in a captured image captured by at least one camera of a stereo camera, and moves a machine body to which the stereo camera is fixed in a direction orthogonal to the line segment.

A program according to one aspect of the present technology allows a computer to function as: a line segment detection unit that detects a line segment in a captured image captured by at least one camera of a stereo camera; and a control unit that moves a machine body to which the stereo camera is fixed in a direction orthogonal to the line segment.

In one aspect of the present technology, the line segment in the captured image captured by at least one camera of the stereo camera is detected, and the machine body to which the stereo camera is fixed is moved in the direction orthogonal to the line segment.

Note that the program can be provided by transmitting via a transmission medium or by recording on a recording medium.

### BRIEF DESCRIPTION OF DRAWINGS

FIG. 1 is a plan view of a drone that is a moving body to which the present technology is applied.

FIG. 2 is a diagram for explaining detection of an electric wire and the like by a stereo camera.

FIG. 3 is a block diagram related to flight control of the drone in FIG. 1.

FIG. 4 is a diagram showing an example of a parallax map and an occupancy grid map.

FIG. 5 is a diagram for explaining a method of calculating an angle R.

FIG. 6 is a flowchart for explaining flight control processing.

FIG. 7 is a flowchart for explaining details of obstacle avoidance action processing in step S17 of FIG. 6.

FIG. 8 is a diagram for explaining avoidance of an electric wire.

FIG. 9 is a block diagram showing a configuration example of an embodiment of a computer to which the present technology is applied.

### MODE FOR CARRYING OUT THE INVENTION

A mode for carrying out the present technology (hereinafter, referred to as an embodiment) will be described below. Note that the description will be given in the following order.

1. Plan view of drone

2. Detection of electric wire and the like by stereo camera

3. Block diagram of drone

4. Flowchart of flight control processing

5. Use case examples

6. Modified examples of camera

7. Application examples other than drone

8. Computer configuration example

### 1. Plan View of Drone

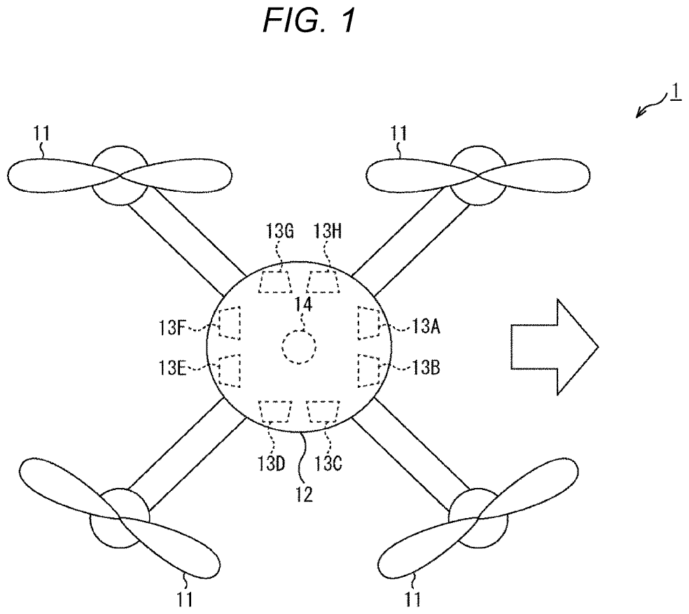

FIG. 1 is a plan view of a drone that is a moving body to which the present technology is applied.

A drone 1 in FIG. 1 is a quad-type flying moving body having four rotors (rotary wings) 11.

Note that, in the present embodiment, the drone 1 is the quad-type flying moving body having four rotors 11, but is not limited thereto. The drone may be, for example, a multicopter having six or eight rotors 11.

A plurality of cameras 13 is disposed in a main body 12 of the drone 1. More specifically, eight cameras 13A to 13H are disposed on a side surface on an outer periphery of the main body 12, and one camera 14 is disposed on a bottom surface of the main body 12. Each of the cameras 13A to 13H provided on the side surface images a subject appearing within a range of a predetermined viewing angle in vertical and horizontal directions with the horizontal direction of the drone 1 as an imaging center. The camera 14 provided on the bottom surface images a subject appearing within a range of a predetermined viewing angle in the vertical and horizontal directions with a lower side which is a ground direction as an imaging center. In a case where the cameras 13A to 13H are not particularly distinguished, they are simply referred to as a camera 13. The number and arrangement of cameras 13 are not limited to the example of FIG. 1, and can be arbitrarily determined.

Among the eight cameras 13 provided on the side surface, a pair of two cameras 13 disposed such that optical axes are parallel constitutes a stereo camera. Specifically, the cameras 13A and 13B constitute a stereo camera, the cameras 13C and 13D constitute a stereo camera, the cameras 13E and 13F constitute a stereo camera, and the cameras 13G and 13H constitute a stereo camera. From two captured images (a pair of captured images) captured by the two cameras 13 constituting the stereo camera, an object existing around the drone 1 and a distance to the object are recognized by the principle of triangulation.

Assuming that a right direction indicated by an arrow in FIG. 1 is a traveling direction of the drone 1, the stereo camera including the cameras 13A and 13B performs imaging in the traveling direction to detect a situation of an obstacle and the like in the traveling direction, and the other cameras 13C to 13H capture images for detecting a situation of an entire periphery of the drone 1.

### 2. Detection of Electric Wire and the Like by Stereo Camera

The drone 1 recognizes an object existing as an obstacle in a traveling direction on the basis of two captured images captured by the stereo camera, autonomously flies while avoiding the obstacle, and moves to a destination. The destination is received from a remote terminal (not illustrated) by wireless communication and the like.

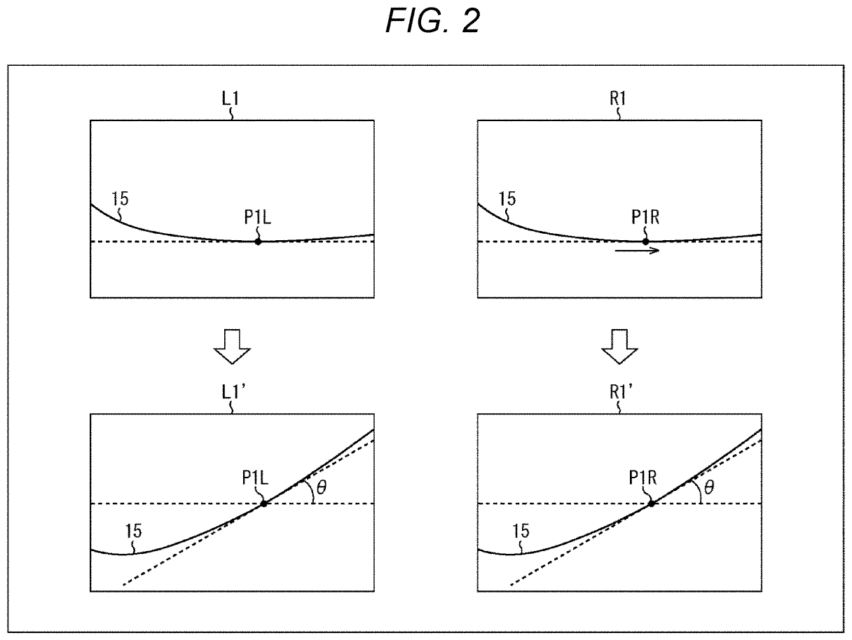

In the object recognition by the stereo camera, it is difficult to detect an object having a small change in texture in a direction of a straight line parallel to a baseline, for example, an object long in a horizontal direction such as an electric wire 15 illustrated in FIG. 2. Note that the baseline is a line segment connecting optical centers of the two cameras 13 constituting the stereo camera.

FIG. 2 illustrates a state in which the electric wire 15 is imaged by the stereo camera.

A captured image L1 (hereinafter, referred to as a left camera captured image L1) is an image captured by a left-side camera which is one of the stereo camera, and a captured image R1 (hereinafter, referred to as a right camera captured image R1) is an image captured by a right-side camera which is another.

In a case where a predetermined object is detected from the left camera captured image L1 and the right camera captured image R1 captured by the stereo camera, first, processing of detecting a corresponding point of an object appearing in the two captured images is performed. In a case where the electric wire 15 is detected, for example, it is necessary to search for a corresponding point P1R which is a point on the right camera captured image R1 corresponding to a predetermined point P1L of the electric wire 15 in the left camera captured image L1. However, the electric wire 15 in the right camera captured image R1 has a small change in texture in a direction of a straight line that passes through the corresponding point P1R in the right camera captured image R1 corresponding to the point P1L and is parallel to a baseline. Accordingly, the corresponding point P1R in the right camera captured image R1 cannot be specified. Note that, in FIG. 2, a horizontal broken line in the image is an auxiliary line for description.

Therefore, the drone 1 is equipped with a control capable of detecting an object having a small change in texture in the direction of the straight line parallel to the base line, such as the electric wire 15 in FIG. 2.

Specifically, by rotating the drone 1 itself at a predetermined angle and performing imaging by the stereo camera, it is possible to search for a corresponding point on the straight line parallel to the baseline.

For example, in a situation where the electric wire 15 illustrated in FIG. 2 is imaged, a machine body is rotated and the stereo camera performs imaging. Then, it is possible to acquire an image in which the electric wire 15 is inclined by a predetermined angle θ, such as a left camera captured image L1′ and a right camera captured image R1′ in FIG. 2. If the left camera captured image L1′ and the right camera captured image R1′ are used, an image in which the electric wire 15 has a small change in texture in the direction of the straight line parallel to the baseline is not obtained, so that the electric wire 15 can be accurately detected.

### 3. Block Diagram of Drone

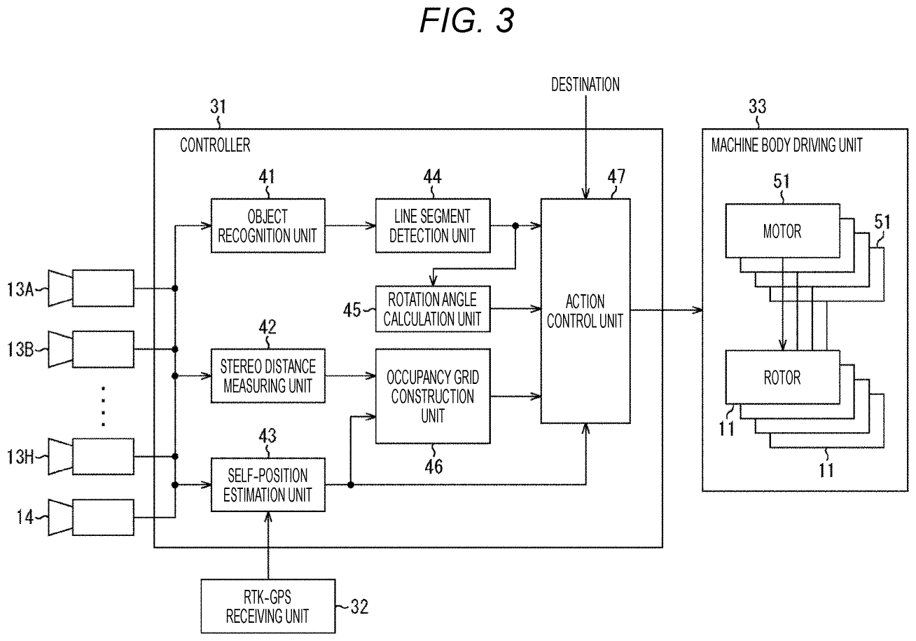

FIG. 3 is a block diagram related to flight control of the drone 1.

The drone 1 includes at least a controller 31, an RTK-GPS receiving unit 32, and a machine body driving unit 33.

The controller 31 recognizes a current location and a surrounding situation of the drone 1 on the basis of images captured by the cameras 13 and 14, and position information, speed information, time information, and the like detected by the RTK-GPS receiving unit 32, and controls flight (movement) of the drone 1. The controller 31 includes, for example, a central processing unit (CPU), a read only memory (ROM), a random access memory (RAM), a microprocessor, or the like, and executes control of the drone 1 by executing a program stored in a storage unit such as the ROM.

The RTK-GPS receiving unit 32 receives both a radio wave from a GPS satellite which is one of global navigation satellite systems (GNSS) and a radio wave from a reference station installed on the ground, thereby detecting (positioning) its own current position with accuracy of several centimeters. Note that the GNSS is not limited to the GPS, and positioning signals of positioning satellites such as GLONASS (Russia), BeiDou (China), Galileo (EU), and quasi-zenith satellite Michibiki (Japan) may be used or used in combination. The RTK-GPS receiving unit 32 supplies the position information, the speed information, the time information, and the like of the drone 1 to a self-position estimation unit 43.

The machine body driving unit 33 includes four rotors 11 and a motor 51 that drives each rotor 11. The machine body driving unit 33 moves the machine body or changes an attitude of the machine body by changing rotation speeds of the four rotors 11 under the control of the controller 31.

The controller 31 includes an object recognition unit 41, a stereo distance measuring unit 42, the self-position estimation unit 43, a line segment detection unit 44, a rotation angle calculation unit 45, an occupancy grid construction unit 46, and an action control unit 47.

The object recognition unit 41 detects (recognizes) an object in a traveling direction on the basis of a captured image captured by one camera 13 (monocular camera) of two stereo cameras (for example, cameras 13A and 13B) that perform imaging in a traveling direction among the plurality of cameras 13. The object recognition unit 41 detects an elongated linear object such as an electric wire, an antenna, or a utility pole among objects included in the captured image, and supplies information that specifies the object (object specifying information), such as a position and size of the detected object, to the line segment detection unit 44. As an algorithm for detecting an arbitrary object from an image, a known method can be adopted. For detecting an elongated linear object such as an electric wire or an antenna, for example, technology disclosed in “Gubbi, Jayavardhana, Ashley Varghese, and P. Balamuralidhar. “A new deep learning architecture for detection of long linear infrastructure.” Machine Vision Applications (MVA), 2017 Fifteenth IAPR International Conference on. IEEE, 2017” can be adopted. Note that, in the present embodiment, the object recognition unit 41 detects the elongated linear object on the basis of the captured image captured by the monocular camera, but may detect the elongated linear object on the basis of a captured image captured by the stereo camera.

The stereo distance measuring unit 42 performs distance measurement using a stereo camera. Specifically, the stereo distance measuring unit 42 generates a parallax map from two captured images (a pair of captured images) captured by the two cameras 13 disposed such that optical axes are parallel to each other, and supplies the parallax map to the occupancy grid construction unit 46. The parallax map is an image obtained by adding, to one captured image of the pair of captured images, a parallax amount corresponding to a distance in a depth direction of an object appearing in the captured image in units of pixels of the captured image. The parallax map is an image indicating depth information corresponding to the captured image, and is also referred to as a depth image.

The self-position estimation unit 43 estimates a current self-position and an attitude of the drone 1 on the basis of the position information and the speed information of the drone 1 supplied from the RTK-GPS receiving unit 32 and the captured images supplied from the plurality of cameras 13 and 14. For example, in a case where a radio wave from a positioning satellite or a base station can be received, the self-position estimation unit 43 estimates the self-position on the basis of the position information measured by the RTK-GPS receiving unit 32. In a place where the radio wave cannot be received, such as indoors or in a tunnel, feature points of the captured images supplied from the plurality of cameras 13 and 14 are detected to estimate the self-position and the attitude by visual-simultaneous localization and mapping (SLAM). The self-position estimation unit 43 supplies the detected self-position and attitude to the occupancy grid construction unit 46 and the action control unit 47.

Note that the drone 1 may further include an inertial measurement sensor such as a gyro sensor, an acceleration sensor, a magnetic sensor, and a pressure sensor. In this case, the self-position estimation unit 43 can estimate the self-position and the attitude with high accuracy using information of those sensors.

The line segment detection unit 44 converts the elongated linear object detected by the object recognition unit 41 into a line segment using Hough transform, and detects the elongated linear object as the line segment. Information on the detected line segment is supplied to the rotation angle calculation unit 45 and the action control unit 47.

The rotation angle calculation unit 45 calculates an angle θ of the line segment detected by the line segment detection unit 44 and supplies a calculation result to the action control unit 47. For example, assuming that the line segment detected by the line segment detection unit 44 is the electric wire 15 in FIG. 2, the rotation angle calculation unit 45 calculates the rotation angle θ on the image of the electric wire 15 in FIG. 2 and supplies it to the action control unit 47.

The occupancy grid construction unit 46 constructs an occupancy grid map (occupancy grid) indicating the presence or absence of an obstacle in a three-dimensional space around the drone 1 by convolving a result of the parallax map supplied from the stereo distance measuring unit 42 in a time direction. Note that the position (self-position) and the attitude of the drone 1 estimated by the self-position estimation unit 43 are also supplied to the occupancy grid construction unit 46.

In a case where P captured images with indexes p=1, 2, 3, . . . , P are obtained by each of the two cameras 13 constituting the stereo camera during a period from current time to a predetermined time ago, assuming that a depth image corresponding to the captured image with the index p is represented by zₚ and a position and an attitude of the stereo camera when the captured image with the index p is obtained is represented by gₚ, a posterior probability P(M|D) of a three-dimensional space map M around the drone 1 when an observation result D={z_{1:P}, g_{1:P}} is given can be calculated by the following Formula (1). Note that z_{1:P}={z₁, z₂, . . . , Z_{P}} and g_{1:P}={g₁, g₂, . . . , g_{P}}. The position and the attitude of an optical center of the stereo camera can be obtained on the basis of the position and the attitude of the drone 1 itself.

$$\begin{matrix}[ Mathematical formula 1 ] & \\ P ( M \vert D ) ∝ P ( M ) {\prod }_{p = 1}^{P} \frac{P ( {m}_{p} \vert {z}_{p} , {g}_{p} )}{P ( {m}_{p} )} & ( 1 )\end{matrix}$$

P(mₚ) in Formula (1) represents a prior probability in the captured image with the index p. P(mₚ|zₚ, gₚ) represents a noise characteristic of a sensor, and corresponds to, for example, an error due to distance resolution in a case where the sensor is a stereo camera. P(M) represents a prior probability of the three-dimensional space map M.

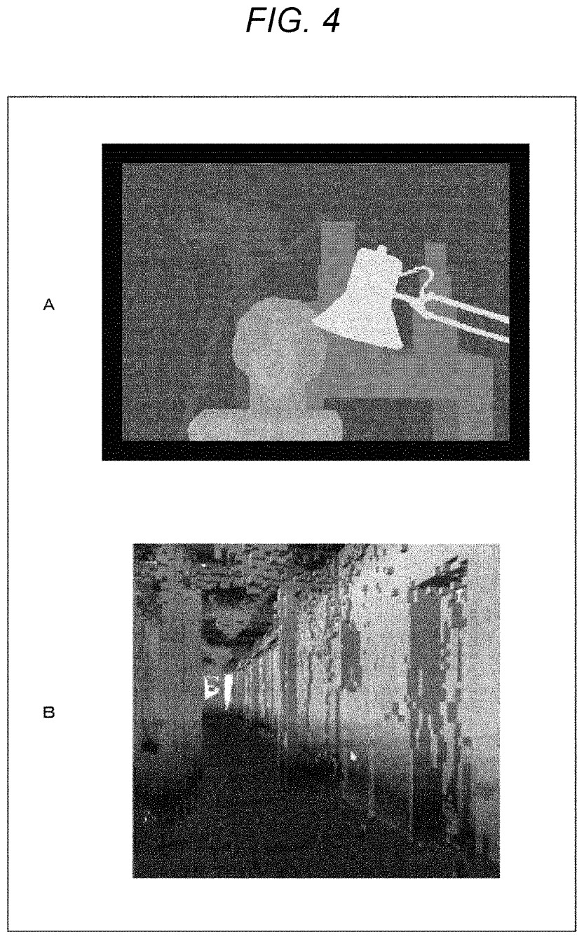

A of FIG. 4 illustrates an example of an example of the parallax map supplied from the stereo distance measuring unit 42. In the parallax map of A of FIG. 4, distance information of each pixel is represented by an 8-bit gray value, and the brighter (whiter) the luminance, the shorter the distance.

B of FIG. 4 illustrates an example of the occupancy grid map constructed by the occupancy grid construction unit 46.

Returning to FIG. 3, the action control unit 47 sets a movement route from a current position of the drone 1 to a destination by using the self-position and the attitude supplied from the self-position estimation unit 43 and the occupancy grid map constructed by the occupancy grid construction unit 46, and controls each motor 51 of the machine body driving unit 33 according to the set movement route. The destination is transmitted from the remote terminal, received by a communication unit (not illustrated), and input to the action control unit 47.

Furthermore, in a case where a line segment of an elongated linear obstacle such as the electric wire 15 in FIG. 2 is supplied from the line segment detection unit 44, the action control unit 47 controls the motor 51 to rotate the machine body in a yaw direction. The action control unit 47 rotates the machine body in the yaw direction until the angle θ of the line segment supplied from the rotation angle calculation unit 45 becomes an angle R.

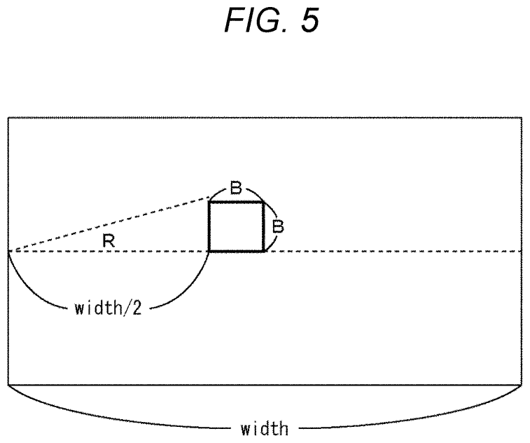

Here, the angle R is determined as follows. As illustrated in FIG. 5, assuming that resolution in a horizontal direction of the camera 13 is width [pixel], and the number of pixels in the horizontal direction and a vertical direction of a block at the time of performing block matching that searches corresponding points of two captured images by the stereo camera is B [pixel], the angle R is calculated by the following Formula (2).

$$\begin{matrix}[ Mathematical formula 2 ] & \\ R = atan \frac{2 B}{width} & ( 2 )\end{matrix}$$

In other words, the angle R is an angle at which a predetermined object in an image center portion moves in the vertical direction by an amount corresponding to a block size of the block matching in the captured image. In a case where the drone 1 moves in the horizontal direction, it moves in a forward tilting attitude with respect to a traveling direction. However, if the machine body in the forward tilting attitude is rotated in the yaw direction, the object (subject) on the captured image can be rotated like the left camera captured image L1′ and the right camera captured image R1′ in FIG. 2.

### 4. Flowchart of Flight Control Processing

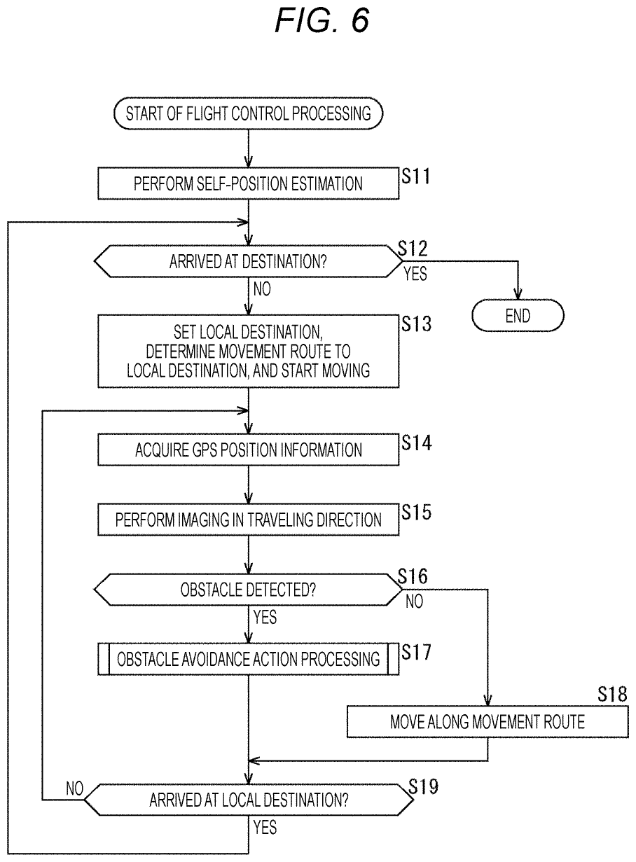

Next, flight control processing when the drone 1 flies to a destination will be described with reference to a flowchart of FIG. 6. This processing is started, for example, when destination information is transmitted from the remote terminal and flight is started.

First, in step S11, the self-position estimation unit 43 performs self-position estimation. In other words, a current position and an attitude of the drone 1 are estimated (determined) on the basis of position information and speed information from the RTK-GPS receiving unit 32 and captured images supplied from the plurality of cameras 13 and the camera 14, and are supplied to the action control unit 47.

In step S12, the action control unit 47 determines whether the drone 1 has arrived at the destination on the basis of the current position thereof. In a case where it is determined in step S12 that the drone 1 has arrived at the destination, the flight control processing ends.

On the other hand, in a case where it is determined in step S12 that the drone 1 has not arrived at the destination yet, the processing proceeds to step S13. The action control unit 47 sets a local destination within a predetermined distance from a current location (hereinafter referred to as a local destination), which corresponds to a passing point in a movement route to a final destination, determines a movement route to the local destination, and starts moving. Note that, in a case where the final destination is present within the predetermined distance from the current location, the destination becomes the local destination.

The movement route to the local destination is determined by calculating a cost when the drone 1 passes through a certain space using a three-dimensional occupancy grid map from the occupancy grid construction unit 46 as an input. The cost represents difficulty of allowing the drone 1 to pass through, and as it is closer to the obstacle, the cost is set higher. In a case where semantic information such as electric wires and buildings is given to the occupancy grid map, the cost can be changed according to the semantic information. For example, a high cost is set to the vicinity of a region recognized as an electric wire or a moving object such as a person. Therefore, a movement route in which the drone 1 keeps a distance from an obstacle having a high cost is determined. A known search algorithm such as an A* algorithm, a D* algorithm, a rapidly exploring random tree (RRT), a dynamic window approach (DWA), and the like can be used to search for the movement route.

In step S14, the RTK-GPS receiving unit 32 acquires GPS position information. More specifically, the RTK-GPS receiving unit 32 detects (measures) a self-position by receiving both a radio wave from the GPS satellite and a radio wave from the reference station installed on the ground.

In step S15, the plurality of cameras 13 captures images. In particular, two adjacent cameras 13 whose traveling direction is an imaging direction perform imaging in the traveling direction, and the other cameras 13 perform imaging of surroundings other than the traveling direction.

The processing in steps S14 and S15 is processing continuously executed during flight, and the GPS position information and the stereo camera image are sequentially updated according to the movement of the drone 1. Then, the occupancy grid map by the occupancy grid construction unit 46 is updated (reconstructed).

In step S16, the action control unit 47 determines whether an obstacle has been detected in the traveling direction.

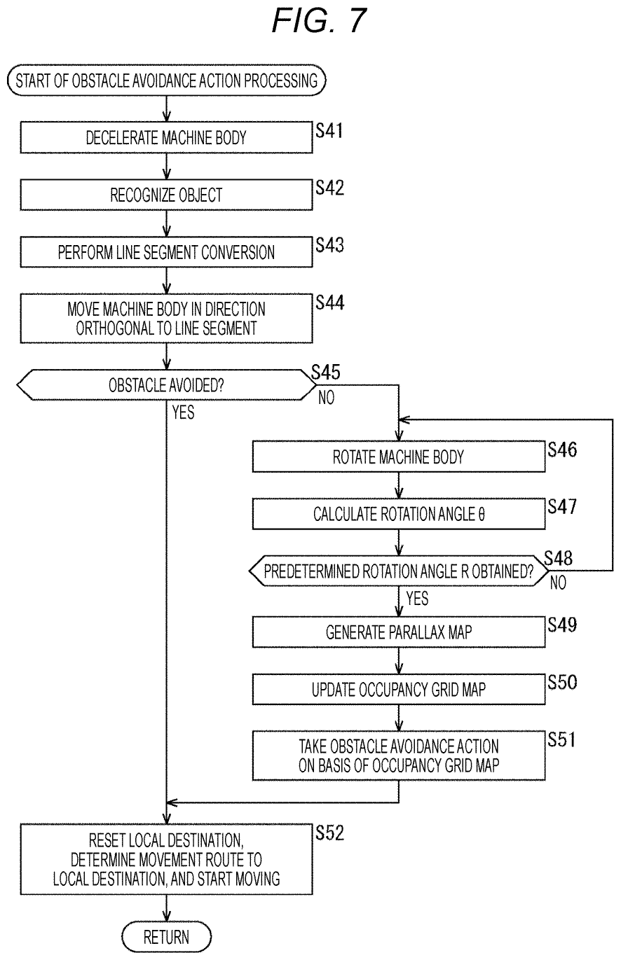

In a case where it is determined in step S16 that the obstacle has been detected in the traveling direction, the processing proceeds to step S17, and the drone 1 executes obstacle avoidance action processing. Details of the obstacle avoidance action processing will be described later with reference to FIG. 7.

On the other hand, in a case where it is determined in step S16 that no obstacle has been detected in the traveling direction, the processing proceeds to step S18, and the drone 1 moves along the movement route set in step S13.

After step S17 or step S18, the processing proceeds to step S19, and the action control unit 47 determines whether the self-position has arrived at the local destination.

In a case where it is determined in step S19 that the self-position has not arrived at the local destination yet, the processing returns to step S14, and the above-described steps S14 to S19 are repeated.

On the other hand, in a case where it is determined in step S19 that the self-position has arrived at the local destination, the processing returns to step S12, and it is determined again whether the drone has arrived at the destination. The processing in steps S13 to S19 is repeated until it is determined in step S12 that the drone has arrived at the destination, and if it is determined that the drone has arrived at the destination, the flight control processing ends.

Next, details of the obstacle avoidance action processing in step S17 executed in a case where it is determined in step S16 of FIG. 6 that an obstacle has been detected in the traveling direction will be described with reference to a flowchart in FIG. 7.

Note that a case of avoiding an elongated linear object that is difficult to recognize as an object, such as the electric wire, the antenna, or the utility pole described above, among obstacles will be described in the obstacle avoidance action processing of FIG. 7.

First, in step S41, the action control unit 47 controls each motor 51 of the machine body driving unit 33 to decelerate the machine body. The drone 1 moves in a forward tilting attitude in the traveling direction at a speed lower than that before the deceleration.

In step S42, the object recognition unit 41 recognizes an object as an obstacle from the captured image obtained by performing imaging in the traveling direction, and supplies object specifying information for specifying the recognized object to the line segment detection unit 44.

In step S43, the line segment detection unit 44 performs line segment conversion for converting the elongated linear object detected by the object recognition unit 41 into a line segment using Hough transform. Therefore, the elongated linear object is detected as the line segment. Information on the detected line segment is supplied to the rotation angle calculation unit 45 and the action control unit 47. The object recognition in step S42 and the line segment detection in step S43 are continuously executed until the obstacle is avoided, that is, until processing in step S52 is started.

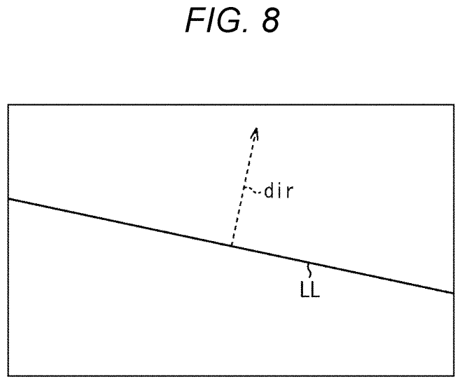

In step S44, the action control unit 47 controls the motors 51 to move the machine body in a direction dir orthogonal to a detected line segment LL as illustrated in FIG. 8. Note that, in FIG. 8, there are two types of directions orthogonal to the line segment LL, an upward direction and a downward direction in FIG. 8, and one direction is selected with reference to the occupancy grid map. In general, the upward direction that is not a ground direction is selected, and is also controlled by the occupancy grid map therearound.

By processing in step S44, the drone 1 moves in the direction dir orthogonal to the detected line segment LL for a fixed time or a fixed distance.

Then, in step S45, the action control unit 47 determines whether the obstacle has been avoided, that is, whether the line segment corresponding to the electric wire and the like is no longer visible from a line-of-sight on the basis of a detection result from the line segment detection unit 44.

In a case where it is determined in step S45 that the obstacle has been avoided, the processing proceeds to step S52 as described later.

On the other hand, in a case where it is determined in step S45 that the obstacle has not been avoided, the processing proceeds to step S46, and the action control unit 47 controls the motors 51 to rotate the machine body in a yaw direction.

In step S47, the rotation angle calculation unit 45 calculates an angle θ of the line segment detected by the line segment detection unit 44 and supplies a calculation result to the action control unit 47.

In step S48, the action control unit 47 determines whether the angle θ of the line segment has become the angle R in the Formula (2).

In a case where it is determined in step S48 that the angle θ of the line segment is not the angle R, the processing proceeds to step S46, and the processing in steps S46 to S48 is repeated. In other words, the drone 1 rotates the machine body in the yaw direction until the angle θ of the line segment becomes the angle R. Therefore, as described in FIG. 2, the elongated object such as the electric wire can be accurately detected from the two captured images of the stereo camera.

Then, in a case where it is determined in step S48 that the angle θ of the line segment has become the angle R, the processing proceeds to step S49, and the stereo distance measuring unit 42 generates a parallax map from two captured images captured by the stereo camera in the traveling direction in a state where the machine body is rotated, and supplies the parallax map to the occupancy grid construction unit 46.

In step S50, the occupancy grid construction unit 46 adds a result of the parallax map supplied from the stereo distance measuring unit 42 to the occupancy grid map, thereby updating (reconstructing) an occupancy grid map indicating the presence or absence of an obstacle in a three-dimensional space around the drone 1.

In step S51, the action control unit 47 controls each motor 51 on the basis of the updated occupancy grid map to take an obstacle avoidance action. Therefore, the drone 1 is moved in a direction of avoiding the elongated object such as the electric wire. If the drone 1 is moved in the direction of avoiding the obstacle, the processing proceeds to step S52.

In both the case where it is determined in step S45 described above that the obstacle has been avoided and the case where the drone has moved in the direction of avoiding the obstacle in step S51, the movement route to the initially set local destination is deviated by the obstacle avoidance action.

Therefore, in step S52, the action control unit 47 resets a local destination, determines a movement route to the local destination, controls each motor 51, and starts moving. A method of resetting the local destination is similar to the setting of the local destination in step S13. If the movement with respect to the reset local destination is started, the obstacle avoidance action processing of FIG. 7 ends.

If the obstacle avoidance action processing in FIG. 7 ends, the process proceeds from step S17 to step S19 in FIG. 6, and it is determined whether the self-position has arrived at the local destination. The subsequent steps are as described with reference to FIG. 6.

As described above, according to the flight control processing performed by the drone 1, the elongated linear object that is difficult to accurately recognize by the stereo camera can be accurately recognized by rotating the machine body in the yaw direction. Therefore, it is possible to accurately fly to the destination while avoiding the elongated linear object. Note that, in the above-described example, it is determined whether the angle θ of the line segment is the target angle R, and the control is performed so as to rotate the machine body in the yaw direction until the angle becomes the angle R. However, a simple control may be performed so as to rotate the machine body in the yaw direction by a predetermined angle without determining whether the angle θ of the line segment is the target angle R.

### 5. Use Case Examples

The flight control for avoiding the obstacle to the drone 1 described above can be applied to the following applications, for example.

1. Delivery of Baggage in Manned Zone Using Drone

A drone moves from a loading place of baggage or a delivery truck to a destination with baggage loaded. The destination is given by a value of a latitude route and the like, and information on surroundings and a movement route thereof is unknown. Furthermore, since an environment such as movement of a person, an animal, or a car is always changing, it is difficult to acquire a three-dimensional structure (an occupancy grid map on a three-dimensional space) of the environment in advance, and there is a possibility that an elongated linear object exists.

2. Flight Along Transmission Line

A drone flies while keeping a certain distance from an electric wire. Since the electric wire is bent and shaken in the wind, it is difficult to grasp a detailed three-dimensional structure in advance. Furthermore, it is in an environment in which altitude of the electric wire is high and deviation of self-position recognition by a stereo camera is likely to occur. A marker and the like for recognizing a self-position may be attached to a fixed facility such as a steel tower, and self-position recognition by the marker may also be performed supplementally.

### 6. Modified Examples of Camera

In the above-described embodiment, in a case where the camera 13 that performs imaging in the traveling direction is fixed to the main body 12 of the drone 1 and the captured image is controlled to be inclined by the angle R, the entire drone 1 is rotated.

However, for example, a camera capable of rotating the camera itself with respect to the main body 12 of the drone 1, such as a first person view (FPV) camera, can also be used as the camera 13. In this case, only the camera is rotated, and the drone 1 does not need to be rotated.

Furthermore, the plurality of cameras 13 is arranged in the horizontal direction as illustrated in FIG. 1. However, for example, a part (at least one) of the plurality of cameras 13 may be arranged in the vertical direction, and two cameras 13 arranged in the vertical direction may be used as stereo cameras instead of rotating the cameras. Since the stereo cameras arranged in the horizontal direction and the stereo cameras arranged in the vertical direction have different textures in the horizontal direction (lateral direction) in the image, it is possible to detect and avoid the above-described elongated object without rotating the camera 13.

### 7. Application Examples Other than Drone

In the above-described example, an example has been described in which the technology of the present disclosure related to movement control for autonomously controlling movement is applied to movement control of the drone that is the flying moving body. However, the technology of the present disclosure can also be applied to a moving body other than the drone.

For example, the movement control of the present disclosure can also be applied to movement control of a vehicle such as an ordinary vehicle or a truck that performs automatic driving. For example, it is effective for recognizing a line segment parallel to a baseline of a stereo camera, such as a guardrail or a road sign.

Further, for example, the present invention is also applicable to a mobile robot that moves in a factory. It is possible to accurately detect and avoid an elongated object such as cable tensioned in the air in the factory.

### 8. Computer Configuration Example

The above-described series of flight control processing can be executed by hardware or software. In a case where the series of processing is executed by the software, a program constituting the software is installed on a computer. Here, the computer includes a microcomputer incorporated in dedicated hardware, a general-purpose personal computer capable of executing various functions by installing various programs, and the like, for example.

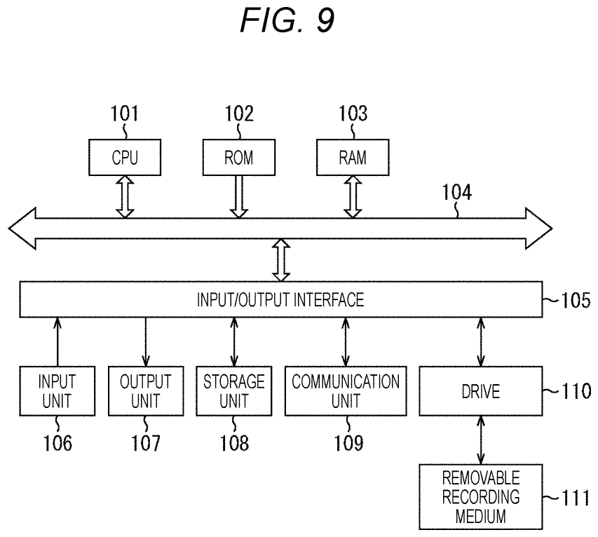

FIG. 9 is a block diagram illustrating a configuration example of hardware of a computer that executes the above-described series of flight control processing by a program.

In the computer, a central processing unit (CPU) 101, a read only memory (ROM) 102, and a random access memory (RAM) 103 are mutually connected by a bus 104.

Moreover, an input/output interface 105 is connected to the bus 104. An input unit 106, an output unit 107, a storage unit 108, a communication unit 109, and a drive 110 are connected to the input/output interface 105.

The input unit 106 includes a keyboard, a mouse, a microphone, a touch panel, an input terminal, and the like. The output unit 107 includes a display, a speaker, an output terminal, and the like. The storage unit 108 includes a hard disk, a RAM disk, a nonvolatile memory, and the like.

The communication unit 109 includes a network interface or the like that performs wired communication or wireless communication. The communication unit 109 performs communication conforming to, for example, the Internet, a public telephone line network, a wide area communication network for a wireless moving body such as a so-called 4G line or a 5G line, a wide area network (WAN), a local area network (LAN), or a Bluetooth (registered trademark) standard. Furthermore, the communication unit 109 performs, for example, short-range wireless communication such as near field communication (NFC), infrared communication, wired communication conforming to a standard such as high-definition multimedia interface (HDMI (registered trademark)) or universal serial bus (USB), or communication via a communication network or a communication path of an arbitrary communication standard. The drive 110 drives a removable recording medium 111 such as a magnetic disk, an optical disk, a magneto-optical disk, or a semiconductor memory.

In the computer configured as described above, for example, the CPU 101 loads a program stored in the storage unit 108 into the RAM 103 via the input/output interface 105 and the bus 104 and executes the program, whereby the above-described series of flight control processing is performed. Furthermore, the RAM 103 appropriately stores data and the like necessary for the CPU 101 to execute various processing.

The program executed by the computer (CPU 101) can be provided by recording on the removable recording medium 111 as a package medium and the like, for example. Furthermore, the program can be provided via a wired or wireless transmission medium such as a local area network, the Internet, or digital satellite broadcasting. In addition, the program can be installed in the ROM 102 or the storage unit 108 in advance.

Note that, in the present specification, the steps described in the flowcharts may be performed not only in chronological order according to the described order, but also in parallel or at necessary timing such as when a call is made, without being necessarily processed in chronological order.

An embodiment of the present technology is not limited to the above-described embodiment, and various modifications can be made without departing from the scope of the present technology.

For example, the present technology can be configured as cloud computing in which one function is shared and jointly processed by a plurality of devices via a network.

Furthermore, each step described in the above-described flowcharts can be executed by one device or shared and executed by a plurality of devices.

Moreover, in a case where one step includes a plurality of processing, the plurality of processing included in the one step can be executed by one device or shared and executed by a plurality of devices.

Note that the effects described in the present specification are merely examples and are not limited, and effects other than those described in the present specification may be provided.

Note that the present technology can have the following configurations.

(1)

A moving body including:

a line segment detection unit that detects a line segment in a captured image captured by at least one camera of a stereo camera; and

a control unit that moves a machine body to which the stereo camera is fixed in a direction orthogonal to the line segment.

(2)

The moving body according to (1) above,

in which the control unit moves the machine body in the direction orthogonal to the line segment for a fixed time or a fixed distance.

(3)

The moving body according to (2) above, further including

an object recognition unit that recognizes an object in the captured image,

in which the line segment detection unit detects the line segment by converting the object in the captured image into the line segment.

(4)

The moving body according to (3) above,

in which the control unit determines whether the object in the captured image has been avoided by moving the machine body in the direction orthogonal to the line segment for the fixed time or the fixed distance.

(5)

The moving body according to (4) above,

in which the control unit rotates the stereo camera or the machine body in a yaw axis direction in a case where the object cannot be avoided by the movement of the machine body in the direction orthogonal to the line segment.

(6)

The moving body according to (5) above,

in which the control unit rotates the stereo camera or the machine body in the yaw axis direction until a rotation angle of the line segment on the captured image becomes a predetermined angle.

(7)

The moving body according to (6) above, further including:

a stereo distance measuring unit that generates a parallax map from the captured image captured by the stereo camera in a state where the rotation angle of the line segment becomes the predetermined angle; and

an occupancy grid map construction unit that constructs an occupancy grid map from the parallax map,

in which the control unit moves the machine body on the basis of the occupancy grid map.

(8)

The moving body according to any one of (1) to (7) above,

in which after moving the machine body, the control unit resets a local destination that is a local destination of the machine body, and moves the machine body to the local destination after the resetting.

(9)

A method of controlling a moving body,

in which the moving body

detects a line segment in a captured image captured by at least one camera of a stereo camera; and

moves a machine body to which the stereo camera is fixed in a direction orthogonal to the line segment.

(10)

A program that allows a computer to function as:

a line segment detection unit that detects a line segment in a captured image captured by at least one camera of a stereo camera; and

a control unit that moves a machine body to which the stereo camera is fixed in a direction orthogonal to the line segment.

### REFERENCE SIGNS LIST

1 Drone
11 Rotor
12 Main body
13 (13A to 13H) Camera
31 Controller
32 RTK-GPS receiving unit
33 Machine body driving unit
41 Object recognition unit
42 Stereo distance measuring unit
43 Self-position estimation unit
44 Line segment detection unit
45 Rotation angle calculation unit
46 Occupancy grid construction unit
47 Action control unit
51 Motor
101 CPU
102 ROM
103 RAM
106 Input unit
107 Output unit
108 Storage unit
109 Communication unit
110 Drive

1. A moving body comprising:
a line segment detection unit that detects a line segment in a captured image captured by at least one camera of a stereo camera; and
a control unit that moves a machine body to which the stereo camera is fixed in a direction orthogonal to the line segment.

2. The moving body according to claim 1,
wherein the control unit moves the machine body in the direction orthogonal to the line segment for a fixed time or a fixed distance.

3. The moving body according to claim 2, further comprising
an object recognition unit that recognizes an object in the captured image,
wherein the line segment detection unit detects the line segment by converting the object in the captured image into the line segment.

4. The moving body according to claim 3,
wherein the control unit determines whether the object in the captured image has been avoided by moving the machine body in the direction orthogonal to the line segment for the fixed time or the fixed distance.

5. The moving body according to claim 4,
wherein the control unit rotates the stereo camera or the machine body in a yaw axis direction in a case where the object cannot be avoided by the movement of the machine body in the direction orthogonal to the line segment.

6. The moving body according to claim 5,
wherein the control unit rotates the stereo camera or the machine body in the yaw axis direction until a rotation angle of the line segment on the captured image becomes a predetermined angle.

7. The moving body according to claim 6, further comprising:
a stereo distance measuring unit that generates a parallax map from the captured image captured by the stereo camera in a state where the rotation angle of the line segment becomes the predetermined angle; and
an occupancy grid map construction unit that constructs an occupancy grid map from the parallax map,
wherein the control unit moves the machine body on a basis of the occupancy grid map.

8. The moving body according to claim 1,
wherein after moving the machine body, the control unit resets a local destination that is a local destination of the machine body, and moves the machine body to the local destination after the resetting.

9. A method of controlling a moving body,
wherein the moving body
detects a line segment in a captured image captured by at least one camera of a stereo camera; and
moves a machine body to which the stereo camera is fixed in a direction orthogonal to the line segment.

10. A program that allows a computer to function as:
a line segment detection unit that detects a line segment in a captured image captured by at least one camera of a stereo camera; and
a control unit that moves a machine body to which the stereo camera is fixed in a direction orthogonal to the line segment.
